(19) United States
(12) Patent Application Publication
(10) Pub. No.: US 2026/0366549 A1
(43) Pub. Date: Nov. 19, 2026

(54) FASTENER SYSTEMS AND COMPONENTS FOR LOADING

(71) Applicant: ASML NETHERLANDS B.V., Veldhoven (NL)

(72) Inventors: Andrew JUDGE, Monroe, CT (US); Andrew HAMILTON, Southington, CT (US); Aamir Khusru KHAN, Stamford, CT (US)

(73) Assignee: ASML NETHERLANDS B.V., Veldhoven (NL)

(21) Appl. No.: 19/145,598

(22) PCT Filed: Dec. 19, 2023
(86) PCT No.: PCT/EP2023/086771

§ 371 Date: Jul. 3, 2025

Related U.S. Application Data
(60) Provisional application No. 63/439,658, filed on Jan. 18, 2023.

(51) Int. Cl. F16B 5/02; F16B 43/00

(52) U.S. Cl. CPC F16B 5/0266; F16B 43/001; F16B 2200/95

(57) ABSTRACT

A fastener assembly including a first washer, a second washer, and a spring disposed between the first washer and the second washer, the spring having a spring constant configured to provide a magnitude of force based upon relative displacement between the first washer and the second washer. A compression limiter is disposed between the first washer and the second washer, the compression limiter configured to limit compression of the spring and the relative displacement between the first washer and the second washer. The first washer and the second washer comprise an annular configuration, the annular configuration having an inner peripheral edge and outer peripheral edge, wherein the spring extends a majority of the distance between the inner edge and the outer edge when measured with the spring being in an uncompressed state.

### CROSS-REFERENCE TO RELATED APPLICATION

This application claims priority of US application 63/439,658 which was filed on 18 Jan. 2023 and which is incorporated herein in its entirety by reference.

### TECHNICAL FIELD

This description relates to fastening systems and components that provide desired loading.

### BACKGROUND

Various applications require precision loading applied from bolted joints. Existing methods include external tools (torque drivers, torque wrenches, etc.), assembly techniques (counted turns, etc.), and/or load indicating features.

Various solutions are not scalable to the small sizes required for fasteners used in certain applications, such as mounted optical assemblies. Other solutions are prone to creating contaminants in the surrounding environment. Other solutions require assembly in the field.

### SUMMARY

In the present disclosure, a spring is used in a washer stack to provide precision force application by design. In one embodiment, a washer stack of two washers has a spring placed between them. This could be a loose hardware stack or a captive hardware assembly. The spring could be a solid or flexure material with a calibrated spring constant (F=k*x, which F is Force, x is displacement, and k is the spring constant) to provide a set force given a set displacement when the washer stack “bottoms out” due to reaching a compression limiter on one or both of the washers.

In one embodiment, the present disclosure relates to a fastener assembly comprising a first washer, a second washer, and a spring disposed between the first washer and the second washer, the spring having a spring constant configured to provide a magnitude of force based upon relative displacement of the first washer relative to the second washer. A compression limiter is disposed between the first washer and the second washer, the compression limiter configured to limit compression of the spring and the relative displacement between the first washer and the second washer. The first washer and the second washer comprise an annular configuration, the annular configuration having an inner circumferential edge and outer circumferential edge, wherein the spring extends a majority of the distance between the inner circumferential edge and the outer circumferential edge when measured with the spring being in an uncompressed state.

In some embodiments, the compression limiter is integrally formed as part of the first washer and projects from the first washer towards the second washer.

In some embodiments, the compression limited is separately formed from the first washer and the second washer.

In some embodiments, a force indicator is disposed between the first washer and the second washer, the force indicator having indicia thereon providing a visual indication of the relative displacement between the first and second washers.

In some embodiments, the visual indication comprises a surrogate for the force provided by the spring.

In some embodiments, the spring is formed from a polymer or elastomer. In some embodiments, the spring is formed from a metal material.

In some embodiments, the compression limiter comprises a continuous annular structure. In some embodiments, the compression limiter comprises a plurality of circumferentially spaced structures.

In some embodiments, a connection is provided between the first washer, the second washer, and the spring, the connection configured to inhibit the first washer, the second washer and the spring from separating from one another.

In some embodiments, the spring is an additively manufactured structure.

In some embodiments, the compression limiter is integrally formed as part of the first washer and projects from the first washer towards the second washer, and further comprising a force indicator integrally formed as part of the second washer and projects from the second washer towards the first washer, the force indicator having indicia thereon providing a visual indication of the relative displacement between the first and second washers.

In some embodiments, a surface of the compression limiter relative to the indicia on the force indicator provides the visual indication of the relative displacement between the first and second washers.

In some embodiments, the spring's radial dimension extends at least 80% of the distance between the inner edge and the outer edge when measured with the spring being in an uncompressed state.

In some embodiments, the spring's radial dimension extends at least 95% of the distance between the inner edge and the outer edge when measured with the spring being in an uncompressed state.

According to another embodiment, the present disclosure pertains to a washer. The washer comprises an additively formed elastic body, the body comprising an annular configuration having flat opposing first and second surfaces spaced from one another. The annular configuration has an inner circumferential edge and outer circumferential edge, wherein voids are formed within the body between the inner edge and the outer edge. The voids within the body enable compression of the body to cause displacement between the first and second surfaces.

In another embodiment, a method is provided for additively forming the aforementioned washer.

In yet another embodiment, there is provided a fastener assembly, comprising a first washer, a second washer, and a spring disposed between the first washer and the second washer, the spring having a spring constant configured to provide a magnitude of force based upon relative displacement of the first washer relative to the second washer. A compression limiter is disposed between the first washer and the second washer, the compression limiter configured to limit compression of the spring and the relative displacement between the first washer and the second washer that may be applied by a fastener. A connection is provided that connects the first washer, the second washer, and the spring, the connection inhibiting the first washer, the second washer and the spring from separating from one another prior to connecting the fastener assembly with the fastener.

In some embodiments, the connection comprises a frictional engagement between the spring and a surface of the first washer, and between the spring and a surface of the second washer.

In some embodiments, the surface of the first washer comprises a surface of the compression limiter, wherein the surface of the second washer comprises a surface of a force indicator.

### BRIEF DESCRIPTION OF THE DRAWINGS

FIG. 1 is a schematic view of an optical assembly incorporating the fastener assembly of the present disclosure.

FIG. 2 is a cross section taken through the line A-A in FIG. 1.

FIG. 3 is a schematic view of an embodiment of the present disclosure.

FIG. 4 is a side view of the embodiment of FIG. 3.

FIG. 5 is a cross-sectional view of the embodiment of FIG. 3, showing the fastener in an uncompressed condition.

FIG. 6 is a cross-sectional view of the embodiment of FIG. 3, showing the fastener in a compressed condition.

FIG. 7A is a perspective view, and FIG. 7B is a side view of another embodiment of the present disclosure.

FIG. 8 is a cross-sectional view of the embodiment of FIGS. 7A and 7B, showing the fastener in an uncompressed condition.

FIG. 9 is a cross-sectional view of the embodiment of FIG. 7A and FIG. 7B, showing the fastener in a compressed condition.

FIG. 10 is a side view showing an enlarged view of a portion of the embodiment of FIG. 7A and FIG. 7B to better illustrate the force limiter in an uncompressed condition.

FIG. 11 is a side view showing an enlarged view of a portion of the embodiment of FIGS. 7A and 7B to better illustrate the force limiter in a compressed condition.

FIG. 12 is a cross sectional view of another embodiment of the present disclosure, showing a washer in an uncompressed condition.

FIG. 13 is a cross sectional view of another embodiment of the present disclosure, showing a washer in a compressed condition.

FIG. 14 is a perspective view of another embodiment of the present disclosure, showing a fastener assembly with a retaining clip.

### DETAILED DESCRIPTION

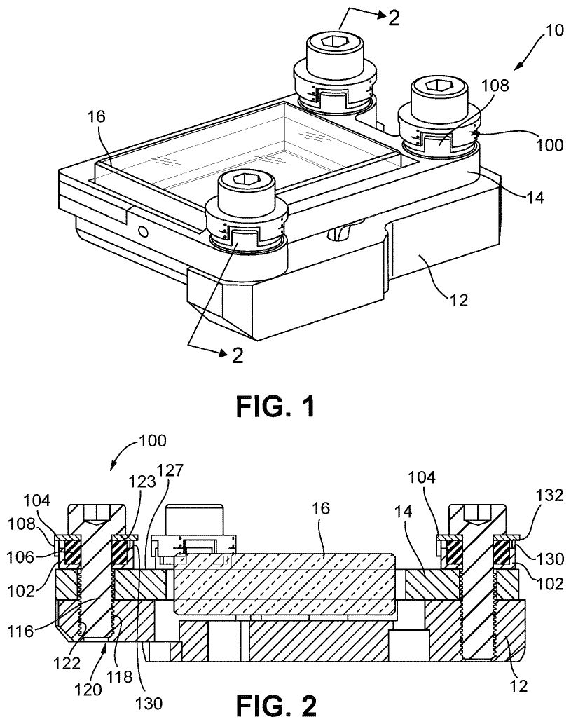

FIG. 1 is a schematic view and FIG. 2 is a cross-sectional view of an optic assembly 10 incorporating a fastener assembly 100 of the present disclosure. The optic assembly 10 includes a fixture 12, and optic mount 14, and an optic 16. The optic 16 is secured at its periphery to the optic mount 14. The optic 16 can be a lens, mirror, diffraction element, beam splitter or the like, and can be used to reflect, transmit, diffract, and/or split radiation. The fixture 12 is used to position, locate, and/or move the optic mount 14 and optic 16 as desired.

The fastener assembly 100 is configured to fasten the optic mount 14 to the fixture 12 in a loaded configuration. In the embodiment of FIG. 1, the fastener assembly 100 includes a first washer 102, a second washer 104, and a spring 106 disposed between the first washer 102 and the second washer 104. The spring 106 has a calibrated spring constant configured to provide a magnitude of force based upon relative displacement (D) of the first washer 102 relative to the second washer 104 (F=k*x, which F is Force, x is displacement, and k is the spring constant). The fastener assembly 100 further includes a compression limiter 108 positioned between the first washer 102 and the second washer 104. The compression limiter 108 is configured to limit compression of the spring 106 and the relative displacement between the first washer 102 and the second washer 104.

The fastener assembly 100 is configured to cooperate with a threaded bolt 116, with threads 118, and a threaded hole 120 in the fixture 12, with threads 122, that can be threadedly secured to threads 118 by relative rotation. While in one embodiment the bolt 116 can be considered as part of the fastener assembly 100, in another embodiment, the bolt 116 can be considered as being a separate structure with which the fastener assembly cooperates.

In an embodiment, upon application of sufficient loading of the spring 106 as a result of clamping force applied by tightening the bolt 116 to the fixture 12 to reduce the distance between the bottom surface 123 of the bolt 116 and the opposing surface 127 of the fixture 12, the leading edge 130 of compression limiter 108 will “bottom out” or engage an opposing surface 132 of the second washer 104.

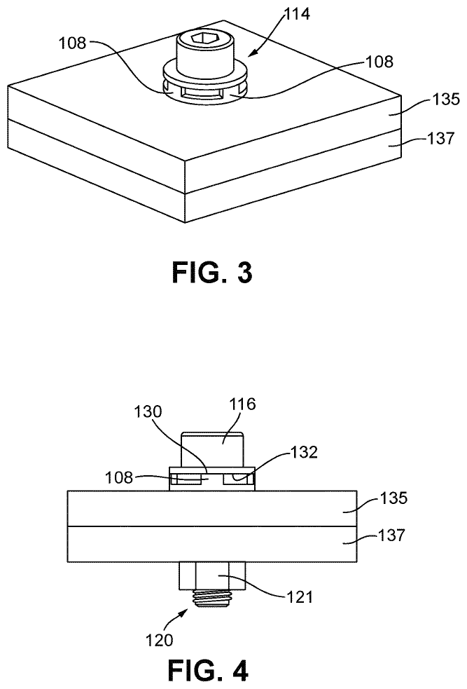

The details of the fastener assembly 100 can be further appreciated in the embodiment of FIGS. 3-6, illustrating portions thereof in isolation from the application environment, and hence described in conjunction with fastening two generic structures to one another, labeled as a first structure 135 and a second structure 137 (e.g., which can be two metal plates, for example).

As shown in the embodiment of FIGS. 3-6, and as described above, the fastener assembly 100 includes the first washer 102, the second washer 104, and the spring 106 disposed between the first washer 102 and the second washer 104.

The spring 106 has a calibrated spring constant configured to provide a magnitude of force based upon relative displacement (D) of the first washer 102 relative to the second washer 104 (F=k*x, which F is Force, x is displacement, and k is the spring constant). The fastener assembly 100 further includes the aforementioned compression limiter 108 positioned between the first washer 102 and the second washer 104. The compression limiter 108 is configured to limit compression of the spring 106 and the relative displacement between the first washer 102 and the second washer 104.

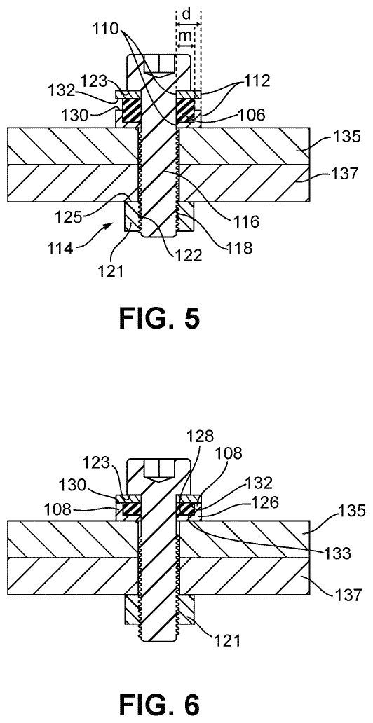

The first washer 102 and the second washer 104 both have an annular configuration. Looking at these structures together, they having an inner circumferential edge 110 and outer circumferential edge 112. As illustrated in FIG. 5. the spring 106 extends a majority (m) (greater than 50%) of the distance (d) between the inner circumferential edge 110 and the outer circumferential edge 112 when measured with the spring 106 being in an uncompressed state. This is explained in greater detail later.

The fastener assembly 100 is configured to cooperate with fastener 114. In one embodiment, the fastener comprises the threaded bolt 116, with threads 118, and in this embodiment, a threaded nut 121, and threaded hole 120 with threads 122, that can be threadedly secured to threads 118 one another by relative rotation. While in one embodiment the fastener 114 can be considered as part of the fastener assembly 100, in another embodiment, the fastener 114 can be considered as being a separate structure with which the fastener assembly cooperates.

In an embodiment, upon application of sufficient loading of the spring 106 as a result of clamping force applied by the fastener 114 (e.g., by tightening the bolt 116 to the nut 121 to reduce the distance between the bottom surface 123 of the bolt 116 and the opposing surface 125 of the nut 121), as shown in FIG. 5 (showing the fastener in the uncompressed condition) and FIG. 6 (showing the fastener in the compressed condition), the leading edge 130 of compression limiter 108 will “bottom out” or engage an opposing surface 132 of the second washer 104. As a result, the compression limiter 108 will limit the amount of loading that can be applied by the spring 106.

In one embodiment, the compression limiter 108 is integrally formed as part of the first washer 102 (e.g., as a cast, stamped, or 3D printed part) and projects from the first washer 102 towards the second washer 104. In the embodiment shown, the compression limiter 108 is formed on the radially outermost portion 126 of the flat torus shaped washer, having a planar top surface 128 and planar bottom surface 133. In another embodiment (not shown), the compression limiter 108 can be formed on a more radially inner portion of the first washer 102.

In another embodiment (not shown), the compression limiter 108 can be formed on the second washer 104 instead of the first washer 102. In yet another embodiment (not shown), the compression limiter can have portions thereof be formed on both the first washer 102 and the second washer 104. In such an embodiment, the compression limiter portions formed on the opposing facing surfaces may come into contact with one another up application of force causing compression of the spring 106, to prevent further compression of the spring 106. In such embodiment, each compression limiter 108 can be made shorter, as the total length of the compression limiter is formed by two portions (one on each washer).

In another embodiment, the compression limiter 108 portions are formed on both opposing facing surfaces may come into contact with planar portions of the opposing washer, at positions spaced from the compression limiters formed on the opposing washer, causing compression of the spring 106, to prevent further compression of the spring 106.

In a different embodiment (not shown), the compression limiter is separately formed from both the first washer 102 and the second washer 104, and is an independent structure provided therebetween to limit compression of spring 106.

In the illustrated embodiments, the compression limiter 108 comprises a plurality of circumferentially spaced structures. However, in another embodiment, the compression limiter 108 comprises a continuous annular structure.

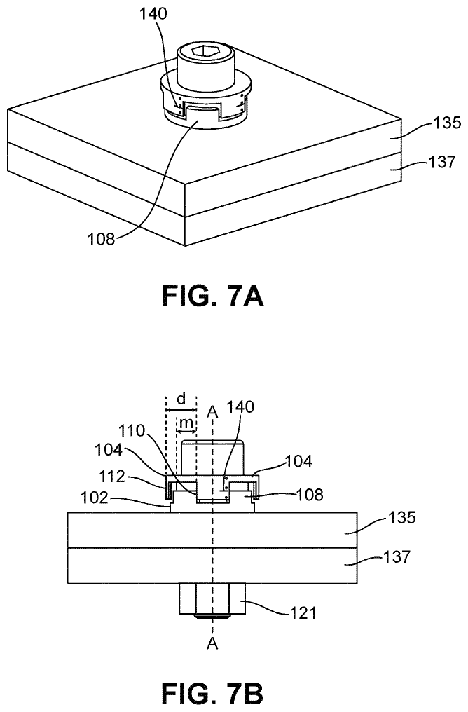

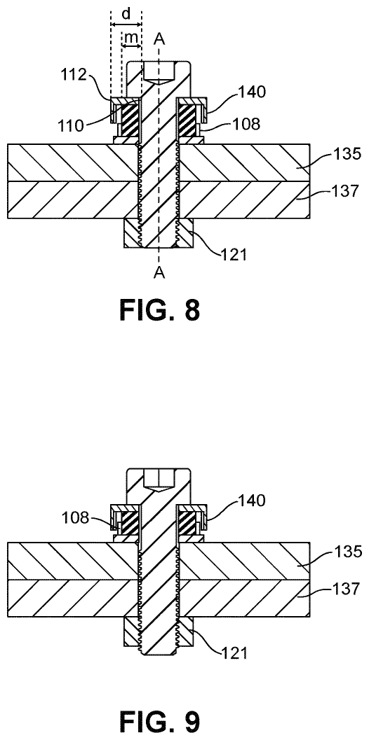

FIGS. 7-11 illustrate another embodiment of the present disclosure. FIG. 7A is a perspective view and FIG. 7B is a side view. FIG. 8 is a cross-sectional view of this embodiment, showing the fastener in an uncompressed condition, while FIG. 9 is a cross-sectional view, showing the fastener in a compressed condition (e.g., at 50% compression). In FIGS. 7-11, the same or similar structures are given the same reference numerals in the embodiments of FIGS. 1-6.

In this embodiment, a force indicator 140 is positioned between the first washer 102 and the second washer 104. In one embodiment, the force indicator 140 is formed on the opposite washer from the one carrying the compression limiter 108. Thus, for example, in the illustrated embodiment, the force indicator 140 is integrally formed as part of the second washer 104, as the compression limiter 108 is formed on the first washer 102. However, the positions of the compression limiter 108 and force indicator 140 can instead be switched to be on the opposite washers. As can be best seen in FIG. 7A, the compression limiter 108 and force indicator 140 are circumferentially offset from one another in a staggered configuration.

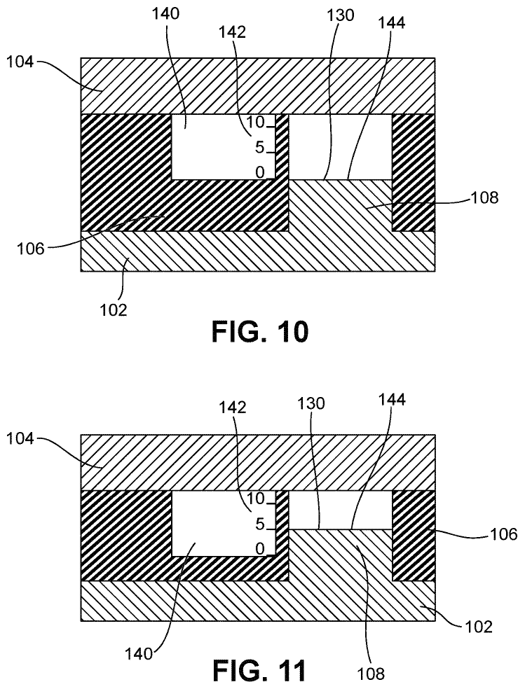

As best shown in FIGS. 10 and 11, the force indicator 140 has indicia 142 formed thereon providing a visual indication of the relative displacement between the first washer 102 and the second washer 104. Thus, in one embodiment, it will be appreciated that the visual indication comprises a surrogate for the force provided by the spring 106.

Force Indicator Embodiment In one embodiment, the indicia 142 formed on the force indicator 140 may be simple gradation marking lines indicative of an amount of displacement of the spring 106. In another embodiment, the indicia 142 may comprise numeric values indicative of an amount of force applied by the spring 106. The indicia may be formed by various methods, such as engraving, stamping, rolling, printing, or formed thereon as part of a 3D printing process, just for example.

The indicia 142 can be visually compared or gauged against a visual indicator 144 to gauge the amount of displacement of, and or force applied by, the spring 106. For example, in the illustrated embodiment, the visual indictor 144 is simply the leading-edge surface 130 of the compression limiter 108, the location of which can be visually compared or measured against against the indicia 142 on the force indicator 140. In another embodiment, the visual indicator 144 can be a mark (e.g., a line or arrow) formed on the compression limiter. Such line or mark on the compression limiter may be formed by various methods, such as engraving, stamping, rolling, printing, or formed thereon as part of a 3D printing process, just for example.

In another embodiment, the indicia 142 are formed on the compression limiter 108 on one of the washers, and the visual indicator 144 is provided as a projection extending from the opposite washer.

The spring 106 is a resilient structure, and in various embodiments is formed from an elastomer, a polymer, or a metal material. In one embodiment, the spring 106 is an additively manufactured structure.

In one embodiment, the washers 102 and 104 are formed from a metal material, such as steel. However, in other embodiments, it may be formed from other materials, such as fiberglass reinforced polymer. In one embodiment, the washers 102 and 104 are 3D printed.

In one embodiment, the bolt 118 may be formed from steel. In various embodiments, the bolt 118 may be an M3 bolt or an M4 bolt, for example, although smaller bolts may also be utilized.

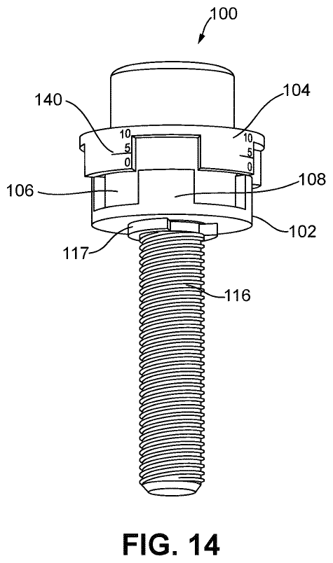

In one embodiment, the fastener assembly 100, including the first washer 102, second washer 104, spring 106, and compression limiter 108 have a connection therebetween so as to form a self-contained, connected assembly structure such that these parts are inhibited from separating from one another prior to these parts being engagement by or associated with the fastener 114. This avoids needing to assemble the fasteners and spring in the field. In one embodiment, the force indicator 140 can also be part of the connected assembly structure. Specifically, these components may be connected by various approaches. In one embodiment, the spring 106 has pockets that frictionally receive projections from the first washer 102 and second washer 104 to create a friction fit that secures the first washer 102 to the second washer 104. In another embodiment, the spring 106 has a radially outer peripheral surface that frictionally engages the radially inwardly facing surfaces of the compressional limiter 108 and of the force indicator 140. In that embodiment, for example, the spring 106 may be specifically shaped for such frictional engagement. For example, in one embodiment, the spring 106 may be a rubber structure having a first portion with a relatively smaller outer diameter dimension or radius that engages the radially inwardly facing inner surface of the compression limiter 108, and a second portion having relatively larger dimension or radius for engaging the radially inwardly facing inner surface of the force indicator 140. In yet another embodiment, the spring 106 is a rubber material that is vulcanized to the opposing surfaces of the first washer 102 and the second washer 104 that apply the compressive force to the spring 106. In yet another embodiment, the spring 106 can be made of any suitable material that can be adhesively connected to the first washer 102 and second washer 104. In yet another embodiment (not shown) a structural retainer or clip is used to retain the washers and spring as an assembly prior to connection with the fastener (e.g., bolt 116). In another embodiment, shown in FIG. 14, a retaining clip 117 is used to capture the fastener assembly with the bolt 116 so that the components shown therein, including the bolt 116 in this embodiment, do not readily separate from one another without application of manual force to remove the retaining clip 117.

As noted previously, the first washer 102 and the second washer 104 both have an annular configuration, and looking at these structures together as an assembly, they define an inner circumferential edge 110 and outer circumferential edge 112. Specifically, the inner circumferential edge is defined as the edge of one (or both, in case of equidistance) of the washers that is closest to the axis (A) of the fastener 114, whereas the outer circumferential edge is defined as the outer edge of one (or both in the case of equidistance) of the washer(s) that is furthest from the axis (A) of the fastener 114. In the embodiment of FIGS. 3-6, the inner circumferential edge and outer circumferential edge of both washers are aligned and hence have the same dimension, to define the dimensions to be measured to determine distance (d). However, in the embodiment of FIGS. 7-9, the inner circumferential edge 110 of both washers 102 and 104 are aligned, but the outer diameter of washer 104 is greater than that of washer 102. Thus, for the embodiment of FIGS. 7-9, outer circumferential edge 112 will be deemed to be the radially outer surface of washer 104 for the purpose of defining the distance or dimension (d). As best illustrated in the embodiments of FIGS. 5 and 8, the spring 106 extends a majority (m) of the distance (d) between the inner circumferential edge 110 and the outer circumferential edge 112 when the spring dimension measured with the spring 106 being in an uncompressed state. Otherwise stated, (m) is greater than 50% of (d) when the spring is measured in the uncompressed condition. When compressed (e.g., as shown in FIGS. 6, 7B and 9, the dimension of spring 106 may expand to be greater than its dimension when at rest (uncompressed).

In another embodiment, the spring 106 radial dimension extends at least 80% of the distance (d) between the inner edge 110 and the outer edge 112 when measured with the spring 106 being in an uncompressed state. In another embodiment, the spring's radial dimension extends at least 95% of the distance between the inner edge 110 and the outer edge 112 when measured with the spring being in an uncompressed state. In another embodiment, the spring's radial dimension extends 100% of the distance between the inner edge 110 and the outer edge 112 when measured with the spring being in an uncompressed state.

### Spring Washer Embodiment

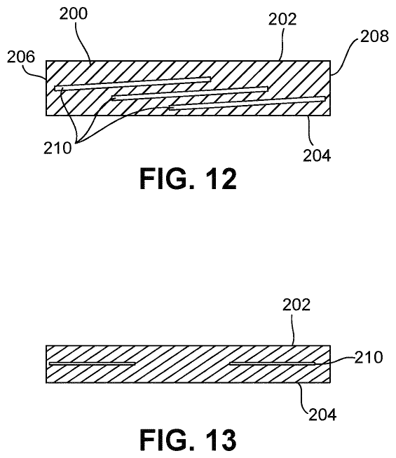

In another embodiment, shown in FIGS. 12 and 13 the spring loading is provided by an integrated washer/spring structure 200 that has a spring constant. Specifically, the washer is formed from additive formation, so as to provide an additively formed elastic body, the body has an annular configuration having flat opposing first surface 202 and second surface 204 spaced from one another. The annular configuration has an inner circumferential edge 206 and outer circumferential edge 208. As shown, voids 210 are formed within the body between the inner edge 206 and the outer edge 208. The voids 210 within the body enable compression of the body to cause displacement between the first surface 202 and the second surface 204. FIG. 12 is a cross sectional view showing the washer 200 in an uncompressed condition, while FIG. 13 is a cross sectional view showing the washer 200 in a compressed condition. The additively manufactured washer 200 is engineered and integrally formed with the voids to that it has a maximum flexure and displacement that “bottoms out” given the precise force desired.

To form the washer/spring structure 200 the elastic body is additively formed such that the body comprises an annular configuration having the flat opposing first 202 and second 204 surfaces spaced from one another. The annular configuration has the aforementioned inner circumferential edge 206 and outer circumferential edge 208. The additive forming process comprises forming voids 210 in the elastic body, the voids being formed within the body between the inner edge and the outer edge. The voids 210 within the body enable compression of the body to cause displacement between the first 202 and second 204 surfaces.

Various embodiments of the present systems and methods are disclosed in the subsequent list of numbered clauses:
1. A fastener assembly, comprising:
   a first washer;
   a second washer;
   a spring disposed between the first washer and the second washer, the spring having a spring constant configured to provide a magnitude of force based upon relative displacement of the first washer relative to the second washer;
   a compression limiter disposed between the first washer and the second washer, the compression limiter configured to limit compression of the spring and the relative displacement between the first washer and the second washer;
   wherein the first washer and the second washer comprise an annular configuration, the annular configuration having an inner circumferential edge and outer circumferential edge, and wherein the spring extends a majority of the distance between the inner circumferential edge and the outer circumferential edge when measured with the spring being in an uncompressed state.
2. The fastener assembly according to clause 1, wherein the compression limiter is integrally formed as part of the first washer and projects from the first washer towards the second washer.
3. The fastener assembly according to clause 1, wherein the compression limiter is separately formed from the first washer and the second washer.
4. The fastener assembly according to any of the above clauses, further comprising a force indicator disposed between the first washer and the second washer, the force indicator having indicia thereon providing a visual indication of the relative displacement between the first and second washers.
5. The fastener assembly according to clause 4, wherein the visual indication comprises a surrogate for the force provided by the spring.
6. The fastener assembly according to any of the above clauses, wherein the spring is formed from a polymer or elastomer.
7. The fastener assembly according to any of the above clauses, wherein the spring is formed from a metal material.
8. The fastener assembly according to any of the above clauses, wherein the compression limiter comprises a continuous annular structure.
9. The fastener assembly according to any one of clauses 1-7, wherein the compression limiter comprises a plurality of circumferentially spaced structures.
10. The fastener assembly according to any of the above clauses, further comprising a connection between the first washer, the second washer, and the spring, the connection configured to inhibit the first washer, the second washer and the spring from separating from one another.
11. The fastener assembly according to any of the above clauses, wherein the spring is an additively manufactured structure.
12. The fastener assembly according to clause 1, wherein the compression limiter is integrally formed as part of the first washer and projects from the first washer towards the second washer, and further comprising a force indicator integrally formed as part of the second washer and projects from the second washer towards the first washer, the force indicator having indicia thereon providing a visual indication of the relative displacement between the first and second washers.
13. The fastener assembly according to clause 12, wherein a surface of the compression limiter relative to the indicia on the force indicator provides the visual indication of the relative displacement between the first and second washers.
14. The fastener assembly according to any of the above clauses, wherein the springs radial dimension extends at least 80% of the distance between the inner edge and the outer edge when measured with the spring being in an uncompressed state.
15. The fastener assembly according to any of the above clauses, wherein the springs radial dimension extends at least 95% of the distance between the inner edge and the outer edge when measured with the spring being in an uncompressed state.
16. A washer, comprising:
   an additively formed elastic body, the body comprising an annular configuration having flat opposing first and second surfaces spaced from one another, the annular configuration having an inner circumferential edge and outer circumferential edge, and wherein voids are formed within the body between the inner edge and the outer edge, and wherein the voids within the body enable compression of the body to cause displacement between the first and second surfaces.
17. A method for forming a washer, comprising:
   additively forming an elastic body such that the body comprises an annular configuration having flat opposing first and second surfaces spaced from one another, the annular configuration having an inner circumferential edge and outer circumferential edge, and
   forming voids in the elastic body during the additive forming, the voids being formed within the body between the inner edge and the outer edge, and wherein the voids within the body enable compression of the body to cause displacement between the first and second surfaces.
18. A fastener assembly, comprising:
   a first washer;
   a second washer;
   a spring disposed between the first washer and the second washer, the spring having a spring constant configured to provide a magnitude of force based upon relative displacement of the first washer relative to the second washer;
   a compression limiter disposed between the first washer and the second washer, the compression limiter configured to limit compression of the spring and the relative displacement between the first washer and the second washer that may be applied by a fastener; and
   a connection connecting the first washer, the second washer, and the spring, the connection inhibiting the first washer, the second washer and the spring from separating from one another prior to connecting the fastener assembly with the fastener.
19. A fastener assembly according to clause 18, wherein the connection comprises a frictional engagement between the spring and a surface of the first washer, and between the spring and a surface of the second washer.
20. A fastener assembly according to clause 18, wherein the surface of the first washer comprises surface of the compression limiter, and wherein the surface of the second washer comprises a surface of a force indicator.

1. A fastener assembly, comprising:
a first washer;
a second washer;
a spring disposed between the first washer and the second washer, the spring having a spring constant configured to provide a magnitude of force based upon relative displacement between the first washer and the second washer;
a compression limiter disposed between the first washer and the second washer, the compression limiter configured to limit compression of the spring and the relative displacement between the first washer and the second washer;
wherein the first washer and the second washer comprise an annular configuration, the annular configuration having an inner peripheral edge and outer peripheral edge, and wherein the spring extends a majority of the distance between the inner edge and the outer edge when measured with the spring being in an uncompressed state.

2. The fastener assembly according to claim 1, wherein the compression limiter is integrally formed as part of the first washer and projects from the first washer towards the second washer.

3. The fastener assembly according to claim 1, further comprising a force indicator disposed between the first washer and the second washer, the force indicator having indicia thereon providing a visual indication of the relative displacement between the first and second washers.

4. The fastener assembly according to claim 1, wherein the spring is formed from a polymer or elastomer.

5. The fastener assembly according claim 1, wherein the spring is formed from a metal material.

6. The fastener assembly according to claim 1, wherein the compression limiter comprises a continuous annular structure.

7. The fastener assembly according to claim 1, wherein the compression limiter comprises a plurality of peripherally spaced structures.

8. The fastener assembly according to claim 1, further comprising a connection between the first washer, the second washer, and the spring, the connection configured to inhibit the first washer, the second washer and the spring from separating from one another.

9. The fastener assembly according to claim 1, wherein the compression limiter is integrally formed as part of the first washer and projects from the first washer towards the second washer, and-further comprising a force indicator integrally formed as part of the second washer and projects from the second washer towards the first washer, the force indicator having indicia thereon providing a visual indication of the relative displacement between the first and second washers.

10. The fastener assembly according to claim 1, wherein a radial dimension of the spring extends at least 80% of the distance between the inner edge and the outer edge when measured with the spring being in an uncompressed state.

11. The fastener assembly according to claim 1, wherein a radial dimension of the spring dimension extends at least 95% of the distance between the inner edge and the outer edge when measured with the spring being in an uncompressed state.

12. A washer, comprising:
an additively formed elastic body, the body comprising an annular configuration having flat opposing first and second surfaces spaced from one another, the annular configuration having an inner peripheral edge and outer peripheral edge, and wherein voids are formed within the body between the inner edge and the outer edge, and wherein the voids within the body enable compression of the body to cause displacement between the first and second surfaces.

13. A method for forming a washer, the method comprising:
additively forming an elastic body such that the body comprises an annular configuration having flat opposing first and second surfaces spaced from one another, the annular configuration having an inner peripheral edge and outer peripheral edge, and forming voids in the elastic body during the additive forming, the voids being formed within the body between the inner edge and the outer edge, and wherein the voids within the body enable compression of the body to cause displacement between the first and second surfaces.

14. A fastener assembly, comprising:
a first washer;
a second washer;
a spring disposed between the first washer and the second washer, the spring having a spring constant configured to provide a magnitude of force based upon relative displacement between the first washer and the second washer;
a compression limiter disposed between the first washer and the second washer, the compression limiter configured to limit compression of the spring and the relative displacement between the first washer and the second washer that may be applied by a fastener; and
a connection connecting the first washer, the second washer, and the spring, the connection inhibiting the first washer, the second washer and the spring from separating from one another prior to connecting the fastener assembly with the fastener.

15. The fastener assembly according to claim 14, wherein the connection comprises a frictional engagement between the spring and a surface of the first washer, and between the spring and a surface of the second washer.

16. The fastener assembly according to claim 14, wherein the surface of the first washer comprises a surface of the compression limiter, and wherein the surface of the second washer comprises a surface of a force indicator.

17. The fastener assembly according to claim 14, wherein the compression limiter is separately formed from the first washer and the second washer.

18. The fastener assembly according to claim 1, wherein the spring is an additively manufactured structure.

19. The fastener assembly according to claim 1, wherein the compression limiter is separately formed from the first washer and the second washer.

20. The fastener assembly according to claim 9, wherein a surface of the compression limiter relative to the indicia on the force indicator provides the visual indication of the relative displacement between the first and second washers.
